(19) United States
(12) Patent Application Publication
(10) Pub. No.: US 2002/0078768 A1
(43) Pub. Date: Jun. 27, 2002

(54) Apparatus and method for extracting a sample from a strip of material

(76) Inventors: Roger Dale Hiatt, Canton, OH (US); Darryl Warren Jones, Akron, OH (US); Thomas David Williams, Hudson, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 09/944,725

(22) Filed: Aug. 31, 2001

Related U.S. Application Data
(60) Provisional application No. 60/229,485, filed on Aug. 31, 2000.

(51) Int. Cl. G01N 1/04

(52) U.S. Cl. 73/864.41; 83/919

(57) ABSTRACT

The present invention discloses an apparatus and method for extracting a sample from a strip of material. The apparatus comprises a roller having a periphery surface, a cutting wheel having a cutting die extending from its periphery, and wherein the material strip advances between the roller and the cutting wheel. During advancement of the material strip, the cutting wheel rotates in coordinated relation and into a position wherein the cutting die engages the material strip and rotates through engagement with the periphery surface of the roller, thereby extracting a sample from the material strip. The method comprises advancing a strip of material between a roller having a hardened periphery surface and a cutting wheel having a cutting die extending from the periphery thereof, rotating the cutting wheel so that the cutting die engages the strip of material and the hardened roller periphery, thereby extracting a sample from said strip, and rotating the cutting wheel to an ejection position, whereby the sample is ejected from the cutting die.

### CROSS REFERENCE TO RELATED APPLICATION

This application claims the benefit of U.S. Provisional Application Serial No. 60/229,485, filed on Aug. 31, 2000.

### FIELD OF INVENTION

The present invention relates generally to an apparatus and method for extracting a sample from a strip of material, and more particularly, to an apparatus and method for automating the extraction of numerous samples from a strip of rubber material for the purposes of performing in-line Theological tests thereon.

### BACKGROUND OF THE INVENTION

It is desirable in numerous production arts to test the physical properties of the manufactured material for quality control. Particularly, in the rubber manufacturing industry, tests are performed on samples of the rubber material to determine the quality and manufacturability of the entire batch. Rheological tests determine the rheological properties of a material which relate to the flow of the material and are of importance in determining the processing characteristics of the rubber.

One of the most, if not the most, significant factors affecting quality and consistency in the manufacture of rubber products is the quality of the rubber used and the predictability and consistency of the rubber as it is processed. In forming rubber articles, the articles are shaped by injection molding, transfer molding, compression molding, extrusion, and other processes, wherein a mass of flowable material is subjected to differential pressures so as to change its shape. The behavior of the material under different conditions of pressure, temperature and shear will determine the process equipment and techniques required to form the final article. Also, since the properties of the flowable material may vary from batch to batch, it is desirable to measure the rheological behavior of a batch before and during its use in the production process to achieve a predictable outcome.

Therefore, in order to maintain quality control in the rubber manufacturing environment, rubber samples are routinely tested at different stages in the manufacturing process. Such measurements may be made for each of a series of samples taken at successive stages of the manufacturing process. For example, the samples may be taken from the raw rubber, from the product of compounding in a primary mixer, and from the product of extrusion, calendering, or injection-molding of the compounded rubber.

It is known in the art to have workers manually cut or remove rubber samples from slabs of material during or after processing. These rubber samples are then transported to a rheological test machine (RPA) or other testing device where quality or process control tests are run. This procedure is labor intensive, time-consuming, inefficient, and not foolproof in finding, segregating, and resolving out-of-control conditions due to time constraints in sampling and forwarding the sample to testing equipment usually found in an on-site lab. Alternately, manufacturers have used capillary rheometers to check sample material during manufacturing. Measuring the rate of extrusion of a sample material though a capillary of known size under a known applied pressure is an accepted method of determining rheological properties of a rubber compound. Although this is an automated process, the test process itself imparts changes to the material under the test and consequently does not reflect the actual material properties. A more efficient and effective method and apparatus is needed which can perform such quality and process control tests by automation, and preferably, in-line during the manufacturing process.

Most rubber manufacturing and fabrication processes involve a strip of material moving along a conveyor at a relatively high velocity. The material is either fed into a piece of processing equipment or is the output of the processing equipment. Taking a sample of this material prior to or after processing by a particular piece of equipment has been nearly impossible without interrupting and stopping the process to remove a sample or changing the material characteristics of the sample. There is a need in the art to provide an apparatus and method which allows a sample to be extracted directly from the strip of conveyed material while in-line production continues and automatically transmitting the sample to an apparatus to test the rheological properties of that material. Such in-line testing and analysis would permit quick and efficient evaluation and possible modification to the manufacturing process to achieve better or higher quality results.

While there is a need for such a sample cutting apparatus, there is also a need for an apparatus that can perform the sample cutting and testing of the rubber material all in the same device. Such an apparatus and method will reduce the time delay between sample cutting and test result reporting by combining the two operations (sample extraction and testing) into a single device. This permits the rheological data to be used for process control and monitoring, and reduces the risk of making non-conforming materials. It also reduces direct labor cost by eliminating the need for an operator to cut, prepare, and test materials. Safety hazards related to mill knife use are also eliminated.

There is a need in the art for an apparatus and method that can utilize testers as real-time testers (e.g. Quality control tool integral with the production process). By allowing the test mechanism to work directly with the extruder or mixer that is producing material in strip or sheet form, the industry can move the quality control function from the lab to the manufacturing floor in a “real-time” fashion of quality control.

A invention that attempts to address such needs is Japanese Publication No. JP405306975A by Akira Hatakeyama et al. which discloses a device for taking a sample of from a sheet of material by a cutter moving at nearly the same speed as the sheet. Particularly, the Hatakeyama et al. publication discloses a device for sampling a sheet of material conveyed on a conveyor belt. The cutter 38 rotates to meet the material transferred on the conveyor belt to punch out a sample. The cutter holds the sample and transfers the sample to a transport slider 65. Slider 65 then rotates and inserts the sample into a pallet 75 which is then conveyed to a test machine. The sample is then handed over to the test machine for testing of the physical properties. The Hatakeyama invention has several disadvantages. First, the punch cut mechanism is not reliable to adequately and consistently cut samples from the sheet of conveyed material. Also, the transfer device is not reliable and may impede the efficient transfer of the samples. Finally, the samples conveyed to the testing device must still be placed by hand within the testing devices. Therefore, the Hatakeyama invention does not efficiently and effective extract samples from sheets of material, nor is the process completely automated so as not to require human intervention during the process.

### SUMMARY OF INVENTION

It is an object of the present invention to provide a reliable, quick, and relatively simple mechanical sample extraction device that extracts samples.

It is a further object of this invention to provide sample extraction apparatus which can automatically extract samples of rubber compounds and transfer those samples directly to a testing mechanism so that the testing procedure can be done “in-line” without greatly interrupting the manufacturing process.

This invention is particularly aimed at the test needs of rubber manufacturers for process control on the manufacturing floor. In this invention, the acquisition of the sample and the subsequent testing of the sample is performed in-line during processing, automatically, and without human intervention. Using this invention a material sample will be extracted from a moving strip and conveyed to a testing mechanism, tested, and unload so another sample can be loaded. The principle benefit of the proposed system is that sampling of the material is tied directly to the mixing, extrusion, or molding process and occurs without operator intervention. Samples for testing are automatically cut from the moving strip of material and then transferred to a Theological tester. The second major benefit is that this process does not cause any change to the material behavior. In effect the actual material behavior is captured in the test.

The present invention comprises an apparatus and method for extracting a sample from a strip of material. The apparatus comprises a roller having a periphery surface, a cutting wheel having a cutting die extending from its periphery, and wherein the material strip advances between the roller and the cutting wheel. During advancement of the material strip, the cutting wheel rotates in coordinated relation and into a position wherein the cutting die engages the material strip and rotates through engagement with the periphery surface of the roller, thereby extracting a sample from the material strip. The method comprises advancing a strip of material between a roller having a hardened periphery surface and a cutting wheel having a cutting die extending from the periphery thereof, rotating the cutting wheel so that the cutting die engages the strip of material and the hardened roller periphery, thereby extracting a sample from said strip, and rotating the cutting wheel to an ejection position, whereby the sample is ejected from the cutting die.

A better understanding of the invention may be obtained by reference to the accompanying drawings and descriptions.

### BRIEF DESCRIPTION OF THE DRAWINGS

FIG. 1 is a cross-sectional view of the extraction apparatus, the transfer mechanism, and the testing mechanism wherein the cutting die engages the strip of material and the roller periphery;

FIG. 2 is an identical view of FIG. 1, wherein the cutting wheel is rotated to a sample ejection position over the transfer mechanism;

FIG. 3 is a cross-sectional isometric view of the extraction apparatus, the transfer mechanism, and the testing mechanism;

FIG. 4 is a perspective view of a cutting die;

FIG. 5 is an exploded perspective view of two cutting die assemblies and a cutting wheel;

FIG. 6 is perspective view of a cutting die assembly and cutting wheel;

FIG. 7 is a cross-sectional view of a cutting die assembly and cutting wheel;

FIG. 8 shows the cutting wheel in different positions during a single revolution; and

FIG. 9 is an illustration of strip of sample material during the extraction process.

### DETAILED DESCRIPTION OF THE PREFERRED EMBODIMENT OF THE INVENTION

With reference now to the drawings, the present invention comprises an apparatus and method for extracting a sample from a strip of material. Although the apparatus for extracting a sample from a strip of material could be a stand-alone apparatus utilized with numerous testing and non-testing devices known in the art, the preferred embodiment disclosed herein describes the invention as utilized with a mechanism for testing the samples, specifically a rubber process analyzer (RPA). Further, although the apparatus and method of the present invention could be utilized to sample or sample and test numerous types of materials (e.g. rubber, polymers, plastic, etc.), the preferred embodiment disclosed herein describes the invention utilizing a rubber material.

Specifically, the present invention disclosed herein can be used wherein a strip of extruded rubber is conveyed between process stations during the manufacturing process. The invention disclosed herein can be utilized as a fully integrated testing machine that prepares and tests rubber and polymers during manufacturing without changing the properties of the materials. Such a preparing and testing mechanism is compact and rugged for positioning as in integral part of the production process next to the primary processing equipment and machinery. The extraction apparatus can be mounted along any section of conveyed material in order to take samples thereof. It should be readily apparent to one skilled in the art that this apparatus and method can be used at any stage of the manufacturing process.

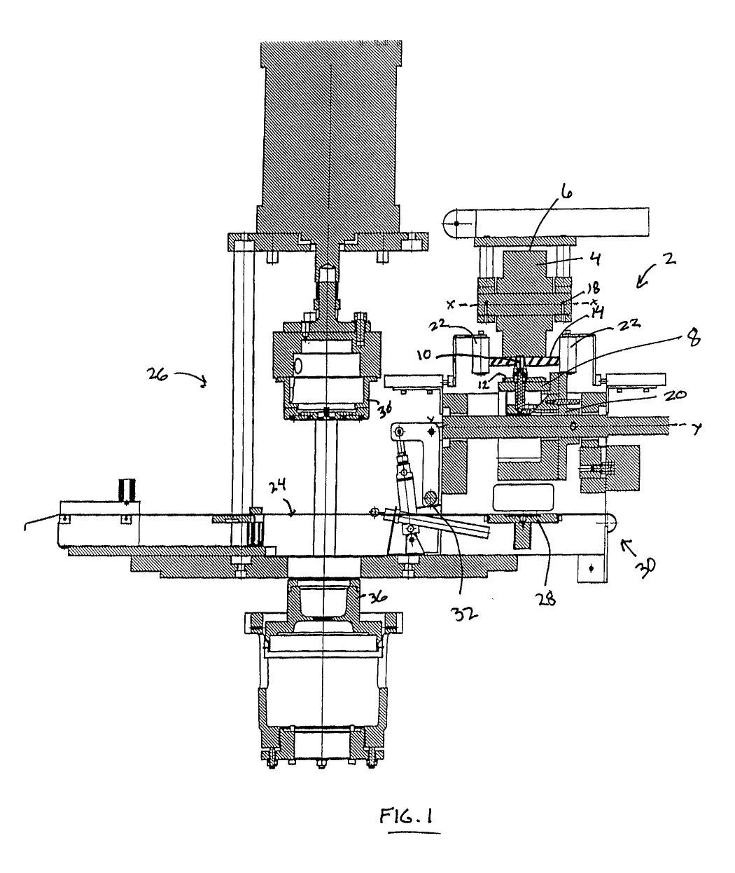

As shown in FIG. 1, an apparatus for extracting a sample from a strip of material, generally designated herein as 2, comprises a roller 4 having a periphery surface 6, a cutting wheel 8 having a cutting die 10 extending from the cutting wheel periphery surface 12, wherein a material strip 14 advances between the roller 4 and the cutting wheel 8. The cutting wheel 8 rotates in coordinated relation to the advance of the material strip 14 wherein the cutting die 10 engages the material strip 14 and the roller periphery surface 6 thereby extracting a sample 3 from the material strip 14.

Cutting wheel 8 is actuated and controlled by a single revolution clutch 16 connected to a power source (not shown). The clutch 16 enables the cutting wheel 8 to stop rotation when disengaged from the power source. The number and position of the stops is dependent upon the number of cutting dies used as explained below. Each stop is positioned so the cutting wheel 8 will stop when a cutting die 10 is in position to deposit the sample 3 removed from the strip 14 onto the conveying mechanism 30 (described below). When actuated, either by a computer-controlled network or by an operator, the clutch 16 releases the cutting wheel 8 to rotate at the speed of a driving motor, and in the direction of the material. The speed of the motor is synchronized to be at, or above, the linear speed of the material so that cutting wheel 8 rotates in coordinated relation with the strip of material 14 advancing through the extraction apparatus 2. If the cutting wheel 8 does not rotate in coordinated relation with the strip of material 14, the strip 14 may be gouged or torn during extraction.

Material strip 14 is advanced between the cutting wheel 8 and roller 4. Drive rollers (not shown) are located on either side of the extraction apparatus 2 to advance the strip of material 14 therethrough. Roller 4 is rotationally mounted on roller die 18 and has axis of rotation x. Cutting wheel 8 is rotationally mounted on cutting wheel die 20 and has axis of rotation y. Although there are numerous configuration in which roller 4 and cutting wheel 8 can be situated, it is preferred that that their respective axes of rotation x,y be coplanar. The preferred embodiment further utilizes the roller 4 as slidably mounted above the cutting wheel 8. So that difference thicknesses of material strips 14 can be advance through the extraction apparatus 2, roller die 18 is moveable in relation to the cutting wheel 8 by means of an air cylinder. Lateral material strip guides 22 confine the strip of material 14 from moving laterally within the extraction area as the strip 14 is advanced therethrough.

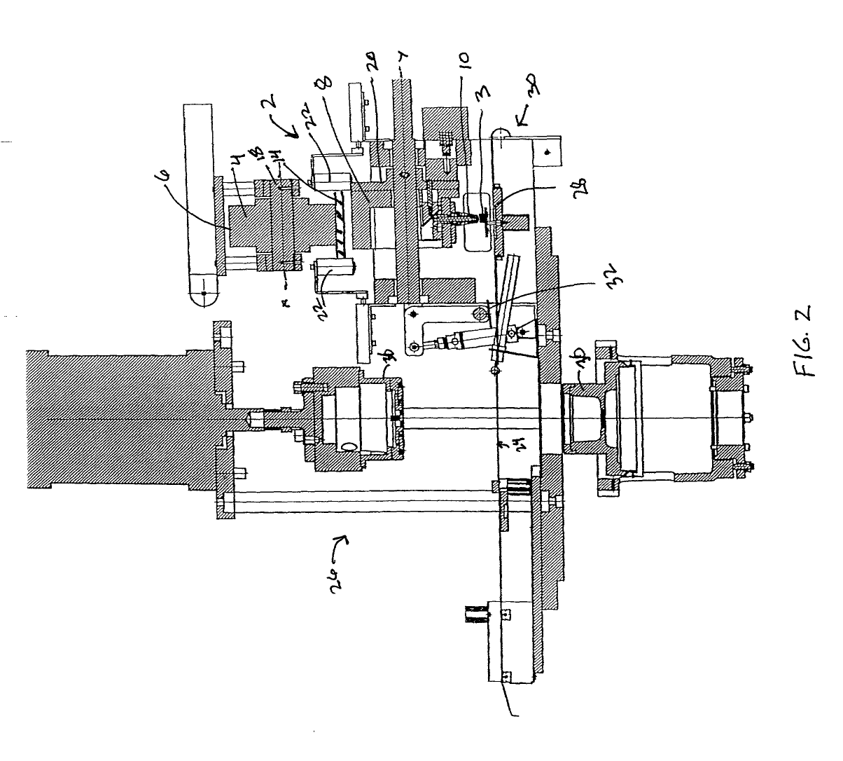

The roller 4 and cutting wheel 8 rotate at an angular velocity equal to the speed of the conveyed strip 14. By using the rotary cutting method, the linear velocity of the material being processed can be matched by the linear velocity of the cutting wheel 8 in a small physical space. Furthermore, rotary cutting has the effect of scooping the sample 3 out of the strip 14, thereby reducing the chance that the sample 3 will stay within the strip 14. In linear punching type cutters, the cut sample has a greater tendency to stay with the strip. Further, because the cutting die 10 engages roller 4 during sample cutting, and preferably the hardened roller periphery surface 6, the sample 3 can be effectively cut from the strip 14 and removed therefrom. FIG. 1 shows the cutting wheel 8 in engagement with the strip of material 14 and roller 4. Therefore, the sample 3 is effectively cut and held within cutting die 10. The roller periphery surface 6 is preferably hardened, and preferably having a periphery of steel, so as to withstand repeated engagement with said cutting die 10. Once a sample 3 is cut, the cutting wheel 8 continues its rotation until it reaches an ejection position. FIG. 2 shows the extraction apparatus 2 in an ejection position where the cutting wheel 8 is rotated to a position where the cutting die 10 is above the conveyance mechanism 30.

It is contemplated that a conveyance mechanism 30 may be incorporated into the extraction apparatus 2 to assist in the automated transfer of samples 3 to the testing mechanism 26. Although numerous conveyance mechanisms and methods of automated transmission of the sample could be used, the preferable conveyance mechanism of the present invention comprises a transport medium conveyance system. Once such transport medium utilizes a film conveyance system as described in U.S. Pat. No. 5,309,768, (the '768 Patent) issued to Mathews et al. on May 10, 1994 and is hereby incorporated by reference herein.

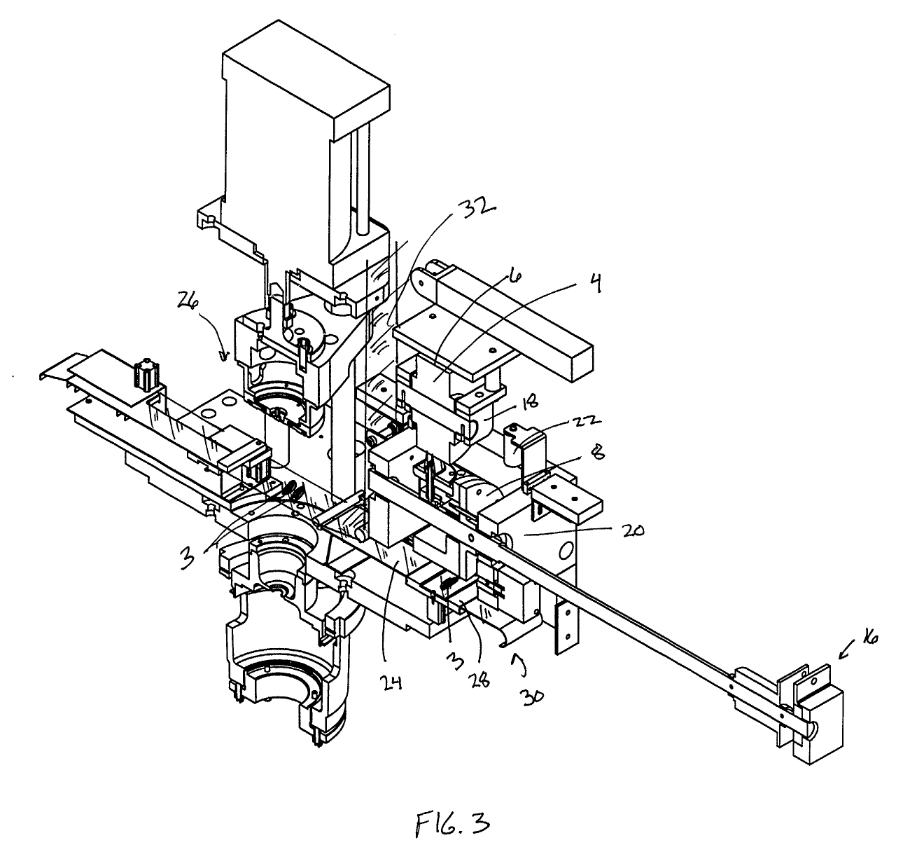

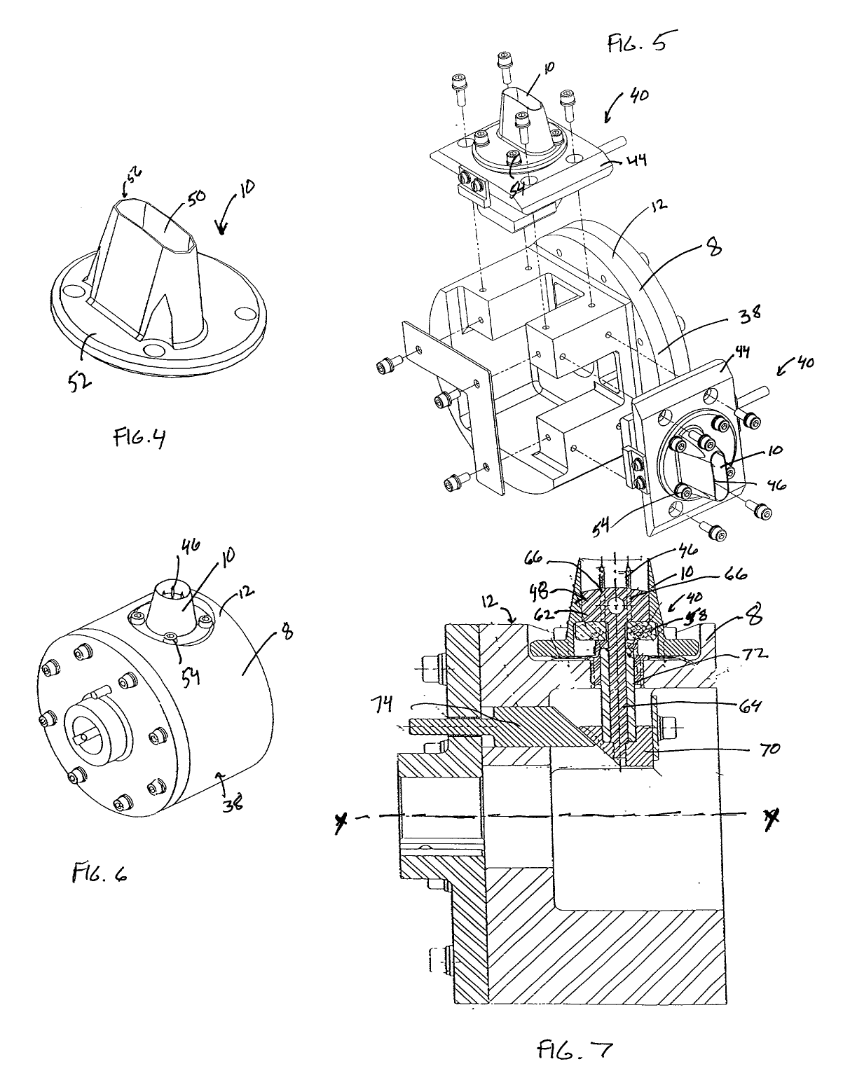

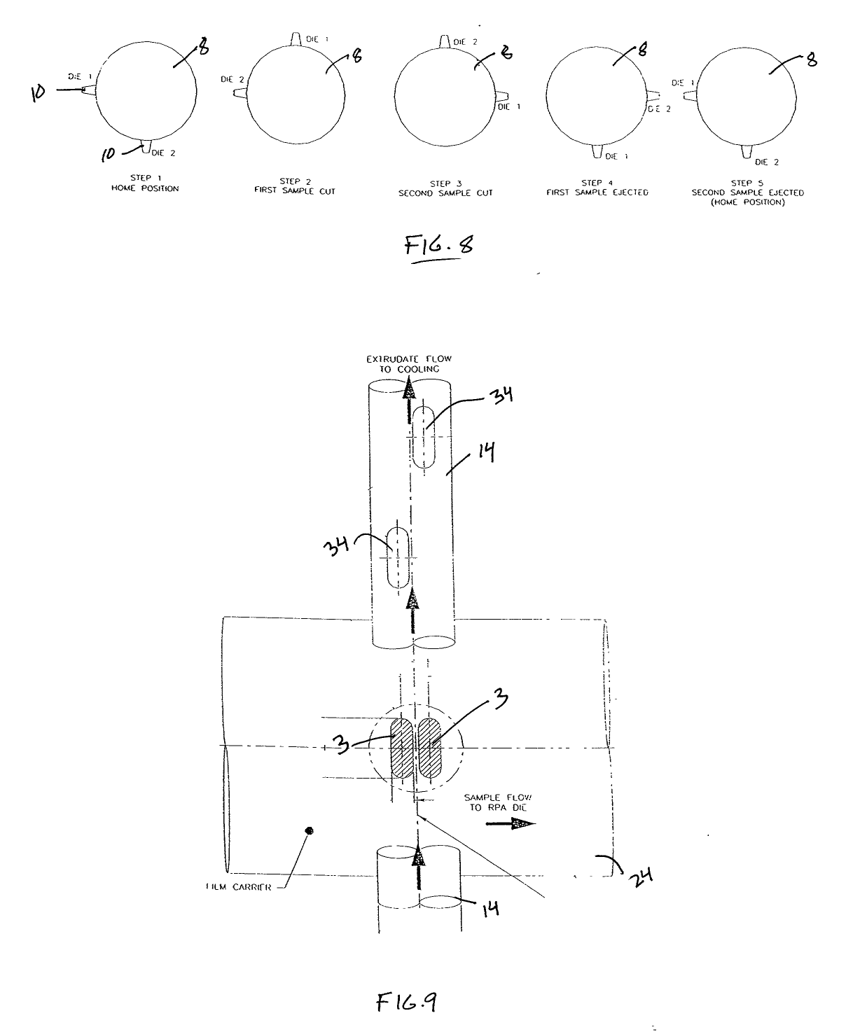

As shown in FIGS. 1 through 3, a transport medium comprised of a strip of film 24, passes through the testing mechanism 26 and is arranged to act as a conveyor belt to carry samples 3 through the testing mechanism 26. The film strip 24 is conveyed beneath the extraction apparatus 2 so that samples 3 may be placed thereon upstream of the testing mechanism 26 and conveyed thereto. The film strip drive means is intermittently activated so that the film strip 24 is stationary during placement of the samples 3 thereon and stationary during testing of the samples. A sample platform 28 is positioned beneath the film strip 24 and the cutting wheel 8 so that during placement of the sample 3 on film strip 24, the film conveyor stops and the sample platform 28 is raised to reduce the distance the sample 3 must travel to be accurately positioned on the film strip 24.

The samples 3 are therein placed side-by-side on the film strip 24 during ejection so as to combine into one testing mechanism sample. After the sample 3 is placed on the film strip 24 by ejection means, the film conveyor mechanism engages and the film 24 is conveyed toward the testing mechanism 26 with the sample 3 thereon. A second strip of film 32 is preferably placed over the sample 3 prior to advancing the sample 3 to the testing mechanism 26, so that the sample 3 is now sandwiched between two strips of film 24, 32. The strips of film containing the sample are conveyed to the testing mechanism 26.

Single or multiple cutting dies 10, particularly shown in FIG. 4, may be used to obtain samples of sufficient volume to conduct Theological tests. The typical industry standard is that a sample, cut to approximately 34.9 mm, will provide sufficient volume to fill the die cavity of a standard rheometer. However, if the material width is less than 34.9 mm wide, the problem of severing the material after cutting a sample exists. To reduce or eliminate severing the material, the preferred embodiment utilizes multiple samples 3 that are cut and placed side-by-side to equal a volume sufficient for testing.

The present invention also utilizes modular components that can be easily interchanged so that various numbers and sizes, shapes, or configurations of cutting dies can be utilized so as to create various numbers and sizes, shapes, or configurations of samples. The preferred sample shape is an oval 10 mm in width and 30 mm in length. Such a sample size has been proven to work for material widths down to 25.4 mm, and material thicknesses down to 9.6 mm, without compromising the strength of the material in further processing. The length of the die can be increased to compensate for thinner materials.

As shown in FIGS. 1 through 3, two cutting dies 10 are positioned at different angular orientations along the cutting wheel periphery 12 so that separate samples 3 may be extracted from the advancing strip of material 14 at discrete points thereon during a single rotation of the cutting wheel 8. Further, as shown in FIG. 5 and shown resultantly in FIG. 9, the cutting dies 10 are laterally offset a distance from the center of cutting wheel periphery 12 so that two samples 3 may be extracted from the strip 14 at alternate positions offset from the centerline of the conveyed strip of a given width. Because the samples 3 removed from the strip 14 create voids 34 that are staggered about the centerline of the strip material 14, and are spaced along the direction of travel, the strip material 14 does not lose strength during subsequent processing operations.

It is contemplated that a testing mechanism 26 may be incorporated into the extraction and conveyance apparatuses 2, 30 to perform physical tests on the sample 3. Numerous testing mechanisms could be used depending on the type of sample and the testing information desired. The preferred embodiment utilized a rubber process analyzer (RPA) to perform rheological test on the sample. One such testing mechanism is described in U.S. Pat. No. 5,079,956, (the '956 Patent) issued to Burhin et al. on Jan. 14, 1992 and is hereby incorporated by reference herein. Therefore, the extracted sample 3 is conveyed to the testing mechanism 26 that performs rheological tests required to determine the process characteristics of the rubber and whether they are in line with accepted values.

The testing apparatus 26, shown in FIGS. 1 through 3, comprises two opposing dies 36 movable between an open position and a closed position. During testing, the conveyance mechanism 30 stops, thereby positioning the sample 3 between the two opposed dies 36. The dies 36 then close and hold the sample 3 therebetween under pressure. The testing mechanism 26 further includes means for controlling the temperature of the dies, means for applying to the sample an oscillatory, rotary shearing force, and means for measuring a torque which is indicative of the response of the sample to the shearing force. The testing mechanism 26 can be controlled and monitored by appropriate electronic or computer network controls to perform the testing and record and interpret the resultant data.

After the testing, the dies 36 open and the tested sample 3 and film 24, 32 is conveyed out of the testing chamber and the next sample 3, which was placed on the film 24, 32 upstream from the testing mechanism 26 during testing of the previous sample 3, is conveyed for testing. The sequence of cutting, ejecting, indexing, and testing continues automatically, all without operator intervention.

As explained herein in further detail, the cutting wheel 8 as shown in FIG. 5 through 7, comprises a generally circular body 38 having a periphery surface 12. The body 38 is capable of receiving one or a plurality of cutting die assemblies 40. The cutting die assemblies 40 are mounted to the body 38 by bolts 42. The cutting die assembly 40 comprises cutting die 10, mounting plate 44, stationary pins 46, and ejector pin 48.

As shown in FIG. 1, the cutting die 10 of the present invention comprises a hollow cutting die body 50 connected at one end to a disk-like mounting plate 52 and open at the opposite end. The mounting plate 52 is mounted to cutting wheel 8 by bolts 54 so that the open end of cutting die 10 faces radially outwardly from the cutting wheel 8. As the cutting die 10 engages the strip of material 14 and the roller periphery 6, a portion of the material from the strip 14 is forced into the hollow body 50 of the cutting die 10 during extraction and retained therein during further rotation of the cutting wheel 8.

Sample retaining pins, or stationary pins 46, are positioned inside the cutting die 10 and are mounted to ring 58 that is set within a counter bore machined into the base of cutting die 10. This construction allows the stationary pins 46 to remain stationary when the ejector pin 48 is actuated to eject the sample 3 held therein. Stationary pins 46 pierce the sample 3 during extraction, thereby aiding in the capture and removal of the sample 3 from the strip of material 14. Stationary pins 46 also assist in holding the sample 3 within cutting die 10 through frictional engagement so as to prevent the sample 3 from falling out of the cutting die 10 during rotation of the cutting wheel 8. Keeping the samples 3 inside the cutting die 10 is of crucial importance, as placement of the samples 3 on the conveying mechanism 30 impacts the sample's position when transferred between the testing dies 36.

Although numerous ejection means can be utilized to eject the sample 3 from the cutting die 10, the preferred embodiment utilizes an ejector pin 48 located within the hollow body 50 of cutting die 10. The ejector pin 48 is slidably mounted therein to eject the sample 3 out of the cutting die 10 during engagement. Ejector pin 48 comprises an ejector head 62 and ejector shaft 64. The outside perimeter of the ejector head 62 is shaped to the dimensions of the inside surface of the cutting die 10, with a minimum clearance. The ejector head 62 can be of any shape corresponding to the shape of the cutting die 10. In the present invention, the ejector pin 48 is oval shaped, but the shape will depend on the shape of the cutting die.

Ejector head 62 also includes apertures 66 through which the ejector pin 48 can slidably mount over the stationary pins 46. Ejector shaft 64 is mounted through mounting plate 44 and connected to an ejector slide 70. Between the mounting plate 44 and ejector slide 70 is an appropriate sized spring 72 that rides along the ejector's cylindrical shaft 64 to return the ejector pin 48 to a ready position after an eject cycle has been performed.

The face of ejector slide 70 is angled to provide an upward motion when a force is applied to the actuator slide 74, which has a mating face. This invention uses a 45° angle on both faces, because the input force and distance equals the output force and distance. The angle may be varied with the understanding that the forces and distances will also change. Therefore, during ejection of the sample, the actuator slide 74 is activated which in turn engages the ejector slide 70. Through the force exerted on the ejector shaft 64, the ejector head 62 slides relative to the stationary pins 46 and through the hollow body 50. Prior to actuation of the ejector pin 48, the sample 3 is held within the die 10 by the stationary pins 46. When the ejector pin 48 is actuated, the ejector head 62 slides relative to the stationary pins 46 and pushes the sample 3 out of engagement with the stationary pins 46 and out the opening of the cutting die 10.

When assembled together, the above items create a modular cutting die assembly 40 that is easily removed and replaced. The modular assembly can also be used at either of the 90° die mounting positions mentioned (each cutting wheel having 4, 90 degree mounting positions, but could have more or less), by repositioning the ejector's shaft into the threaded hole that corresponds to the orientation of the cutting die.

As shown in FIG. 5, the cutting die assembly 40 is attached to the cylindrical drum of the cutting wheel 8 using four mounting bolts. When installed, the ejector slide 70 will travel between machined surfaces within the cylindrical drum to prevent sideways deflection. The face opposite the angled face of the ejector slide 70 travels against a retaining plate, to prevent deflection caused by the forces created by the actuator slide 74 when an ejection cycle occurs. The angled face will slide against the mating face on the actuator slide 74.

The actuator slide 74 is installed and travels within a pocket machined into the cylindrical drum. The pocket is toleranced to minimize up and down movements of the actuator slide 74 when an eject cycle occurs. The angled face of the actuator slide 74 mates with the angled face of the ejector slide 70, and creates a 90° angle between the cylindrical shafts installed in each block.

The cylinder fix plate is used to couple the cylindrical drum, with cutter die assembly and actuator slide 74 in place, to the shaft of the cutting wheel. Clearance holes, with properly sized bushing, are positioned along the face of the cylinder fix plate, and allow the cylindrical shaft of the actuator slide to pass through. The cylinder fix plate is then coupled to the shaft of the rotary cutter by a keyway and pin. The pin prevents axial displacement of the rotary cutter when the ejection air cylinder is actuated during an eject cycle.

The cutting wheel shaft is installed in bearings that are fitted into the cutter framework. The cutter framework is an interlocking steel structure that provides rigid mounting between the rotary cutter and the rheometric instrument. The cutter framework is also an integral part of the ejection cycle, and the “easy feed” inlet, outlet and vertical material guidance system, as well as the sample platform are mounted to it.

Precautions have been taken to ensure that hot, sticky rubber or other sample material does not stick to any parts of the cutting mechanism. Therefore, the inside and outside surfaces of the die, the face of the ejector, the stationary pins, and the roller periphery 6, are coated with a generally non-adhesive substance. The preferred coating is Permalon #M-15, manufactured by Russell Products Co. of Cleveland Ohio. A substrate is also applied to the outside surface of the parts, prior to the coating application, to enhance coating adhesion properties. The Permalon #M-15 coating was selected due to it's superior non-stick capabilities. Tack testing, using the patented BFGoodrich Tack Tester, was performed on several different coatings to determine the best nonstick coating for green (uncured) rubber. During testing, the Permalon coating was compared to Teflon, Xylan, Nedox, and WS2, all coatings manufactured and applied by Russell Products Co. The testing was performed by an independent research facility, Smithers Scientific Services, and clearly showed Permalon #M-15 to be the superior non-stick coating.

Applying a non-stick coating to the outside surface of the die prevents the material from sticking to the die during the cutting cycles. Coating the inside surfaces of the cutting die 10 and stationary pins 46 prevents material from sticking thereto during an ejection cycle. Additionally, the outside surface of the cutting die 10 has a draft angle (preferably 10°) and prohibits the material from becoming wrapped around the cutting die 10 when samples 3 are being extracted from the material. Ejector head 62 is also coated with Permalon #M-15 to prevent samples 3 from sticking to the ejector pin 60 when placed on the conveyor mechanism 30. In operation, the samples 3 will stick to the conveyor film 24 and not to the ejector pin 48.

The operation of the cutting cycle is shown in FIG. 8. Although a single or plurality of cutting dies assemblies 40 can be used, FIG. 8 shows the cutting wheel 8 utilizing two cutting die assemblies 40. The cutting wheels of FIG. 8 are shown as viewed from the testing mechanism into the extraction apparatus and rotate in a clockwise direction in coordinated relation with the strip of material advance thereabove.

Step 1 shows the cutting wheel 8 in its home position. Upon actuation, the cutting wheel 8 rotates in a clockwise position to a first sample extraction position (Step 2) wherein the first cutting die 10 is in a vertical position wherein it engages the strip of material 14 and the hardened roller periphery surface 6. At step two, the sample material is forced into the cutting die 10 by rolling engagement of the cutting die opening and the roller periphery surface 6. With the roller 4 having a hardened periphery surface, preferably steel, the sample is effectively cut and extracted from the material strip 14. The sample 3 is therefore held within the first die during further rotation. Step 3 shows the cutting wheel 8 further rotated in a clockwise direction so that the second die 10 engages the strip of material 14 and the hardened roller periphery surface 6, thereby cutting and extracting a second sample 3 from the material strip 14 that is held within the second die 10 during further rotation. Further clockwise rotation permits the cutting wheel 8 to rotate to the first sample ejection position (step 4). At this position, the first clutch stop position is encountered and the clutch mechanism 16 stops the rotation of the cutter wheel 10 to permit the ejection of the first sample 3 onto the conveyance mechanism 30. During an ejection cycle, the sample platform 28 is raised below the cutting die 10 to a distance that is less than the thickness of the extracted sample, prior to sample ejection. An air cylinder is used to raise the platform 28. When the platform 28 is in position, the ejector pin 48 for the first die is actuated to eject and press the first sample 3 cut from the material 14 onto the conveying system 30. Upon the return stroke of the ejector pin 48, the sample platform 28 is lowered. After the first sample 3 is ejected, the clutch mechanism 16 re-engages and the cutter wheel 8 further rotates in a clockwise direction to its home position. At this position, the second clutch stop position is encountered and the clutch mechanism 16 stops the rotation of the cutter wheel 8 to permit the ejection of the second sample 3 onto the conveyance mechanism 30. The sample platform 28, with the first sample 3 in position on the conveying system 30, is raised again to minimize the distance the second sample 3 must travel when ejected. The ejector pin 48 for the second die is then actuated, and the second sample 3 is deposited on the conveying system 30. Upon the return stroke of the ejector pin 48, the sample platform 28 is lowered. The conveying system (haul off unit) is then actuated to advance the ejected samples into the test head. (Note that electric or hydraulic cylinders could also be used). As the sample is ejected from the die, it is sandwiched between the ejector and sample platform, and is thus positively placed on the conveying system. Prior to lowering the sample platform, the air cylinder is deactivated and the spring returns the ejector pin to a ready position.

The method for extracting a sample from a material strip comprises advancing a strip of material 14 between a roller 4 having a hardened periphery surface 6 and a cutting wheel 8 having a cutting die 10 extending from the periphery thereof, rotating the cutting wheel 8 so that the cutting die 10 engages the strip of material 14 and the hardened roller periphery 6, thereby extracting a sample 3 from the strip 14, and rotating the cutting wheel 8 to an ejection position whereby the sample 3 is ejected from said cutting die 10.

In another embodiment, a method for removing a material sample 3 from a material strip 14 and testing the material comprises cutting a sample 3 of material utilizing a rotary die cutting mechanism 2, loading the sample 3 between strips of a transport medium, conveying the strips containing the sample therebetween to a testing mechanism 26, performing tests on the sample held between the strips 24, 32 to determine the physical properties of the sample 3; and unloading the sample 3 from the testing mechanism 26.

While the preferred embodiment of this invention has been disclosed, it should be understood that modifications and adaptations thereof could occur to persons skilled in the art. Other features and aspects of this invention will be appreciated by those skilled in the art upon reading and comprehending the disclosure.

Having thus defined the invention, we claim:

1. An apparatus for extracting a sample from a strip of material, said apparatus comprising:
a roller having a periphery surface;
a cutting wheel having a cutting die extending from its periphery; and
wherein said material strip advances between said roller and said cutting wheel, said cutting wheel rotating in coordinated relation to the advance of said material strip, said cutting wheel rotating into a position wherein said cutting die engages said material strip and rotates through engagement with said periphery surface of said roller thereby extracting a sample from said material strip.

2. The apparatus of claim 1 wherein said periphery surface of said roller is hardened so as to withstand repeated engagement with said cutting die.

3. The apparatus of claim 2 wherein said periphery surface is coated with a generally non-adhesive substance so that said strip of material does not adhere to said periphery surface of said roller during extraction of said sample.

4. The apparatus of claim 3 wherein said hardened periphery surface of said roller comprises steel.

5. The apparatus of claim 1 wherein said cutting wheel has a plurality of cutting dies extending from its periphery.

6. The apparatus of claim 1 wherein said cutting die comprises:
A hollow body connected at one end to the periphery of said cutting wheel and open at the opposite end, wherein said sample is retained within said hollow body after extraction from said strip.

7. The apparatus of claim 6 further comprising a ejector means located within said hollow body so that engagement of said ejector means forces said sample out of said hollow body.

8. The apparatus of claim 7 wherein said ejector means comprises an ejector pin located within said hollow body for forcing said sample out of said opening during actuation thereof.

9. An apparatus for extracting a sample from a strip of material, said apparatus comprising:
a roller having an axis of rotation x and a hardened periphery surface;
a cutting wheel having an axis of rotation y that is coplanar to said axis of rotation x;
a cutting die extending from the periphery of said cutting wheel, said cutting die comprising a generally hollow body connected at one end to the periphery of said cutting wheel and open at the opposite end thereof;
wherein said material strip advances between said roller and said cutting wheel, said cutting wheel rotating in coordinated relation to the advance of said material strip, said cutting wheel rotating into a position wherein said open end of said cutting die engages said material strip and rotates through engagement with said hardened periphery surface of said roller thereby extracting a sample from said material strip and retaining said sample within said hollow body.

10. The apparatus of claim 9 wherein said cutting die is removably mounted to said cutting wheel to permit cutting dies of various shapes, sizes, and configurations to be used to extract samples.

11. The apparatus of claim 9 further comprising at least one sample retaining pin located within said hollow body and connected at one end to said cutting wheel, said at least one sample retaining pin piercing said sample during the extraction thereof and holding said sample within said hollow body by frictional engagement during rotation of said cutting wheel.

12. The apparatus of claim 9, further comprising a second cutting die extending from the periphery of said cutting wheel to extract a second sample from said material strip during a single revolution of said cutting wheel.

13. The apparatus of claim 12 wherein the first die is laterally offset a distance from the center of the cutting wheel periphery so that the first sample is extracted off-center from said material strip of given width.

14. The apparatus of claim 13 wherein said second cutting die is laterally offset a distance from the center of the cutting wheel periphery opposite that of said first die so that said second sample is extracted off-center from said material strip of given width.

15. The apparatus of claim 14, wherein said first and second cutting dies are located 90 degrees apart on the periphery of said cutting wheel so that the samples taken from a material strip of given width are staggered along the length thereof.

16. An apparatus for extracting a sample from a material strip and testing the physical properties of said sample, said apparatus comprising:
a roller having a peripheral surface;
a cutting wheel having a cutting die extending from its periphery;
wherein said material strip advances between said roller and said cutting wheel, said cutting wheel rotating in coordinated relation to the advance of said material strip, said cutting wheel rotating into a position wherein said cutting die engages said material strip and rotates through engagement with said periphery surface of said roller thereby extracting a sample from said material strip; and
means for ejecting said sample from said cutting die; and
means for conveying said sample to a testing mechanism for testing the physical properties of said sample.

17. The apparatus of claim 16, wherein said means for ejecting the sample is located within said cutting die so that engagement of said ejector means forces said sample out of said cutting die and onto said conveying means.

18. The apparatus of claim 17, wherein said ejector means comprises an ejector pin located within said cutting die, that when actuated, forces said sample out of said cutting die.

19. The apparatus of claim 16, wherein said means for conveying said sample comprises a strip of film material which passes through said testing mechanism and is arranged to act as a conveyer belt, samples to be tested are located on the film material upstream of the testing mechanism, and are in turn conveyed to the testing mechanism and removed from the testing mechanism by intermittent activation of film strip drive means.

20. The apparatus of claim 17 further comprising a second strip of film material placed over the sample material prior to advancing to the testing mechanism so that the samples are sandwiched between the first and second strips of film material.

21. A method for extracting a sample from a material strip comprising:
advancing a strip of material between a roller having a hardened periphery surface and a cutting wheel having a cutting die extending from the periphery thereof;
rotating said cutting wheel so that said cutting die engages said strip of material and said hardened roller periphery, thereby extracting a sample from said strip; and
rotating said cutting wheel to an ejection position, whereby said sample is ejected from said cutting die.

22. A method for removing a material sample from a material strip and testing said material, said apparatus comprising:
cutting a sample of material utilizing a rotary die cutting mechanism;
loading the sample between strips of a transport medium;
conveying said strips containing said sample therebetween to a testing mechanism;
performing tests on the sample held between the strips to determine the physical properties of the sample; and
unloading the sample from the testing mechanism.
